(19) United States
(12) Patent Application Publication
(10) Pub. No.: US 2026/0054749 A1
(43) Pub. Date: Feb. 26, 2026

(54) ELECTRONIC DEVICE AND METHOD OF CONTROLLING MINIMUM RISK MANEUVER

(71) Applicant: ELECTRONICS AND TELECOMMUNICATIONS RESEARCH INSTITUTE, Daejeon (KR)

(72) Inventors: KYOUNG HWAN AN, Daejeon (KR); Ki Tae Kim, Daejeon (KR); JINWOO KIM, Daejeon (KR); Jinhong NOH, Daejeon (KR); MYUNGWOOK PARK, Daejeon (KR); MyungIn Ji, Daejeon (KR); Dooseop Choi, Daejeon (KR)

(21) Appl. No.: 19/271,464

(22) Filed: Jul. 16, 2025

(30) Foreign Application Priority Data
Aug. 23, 2024 (KR) 10-2024-0113649

(51) Int. Cl. B60W 60/00; B60W 30/09

(52) U.S. Cl. CPC B60W 60/0015; B60W 30/09; B60W 60/0013; B60W 2520/10; B60W 2552/05; B60W 2554/20; B60W 2555/20

(57) ABSTRACT

Provided is an electronic device including: a sensor module; a memory storing map data; and a processor functionally connected to the sensor module and the memory, wherein, when it is determined to execute a minimum risk maneuver (MRM) mode during autonomous driving, the processor recognizes a road structure and a static road object at a current location and a forward area from the current location based on the sensor module and map data, and determines a stopping method of the MRM mode according to a result of the recognition of the road structure and the static road object, and stops the vehicle with the determined stopping method.

### CROSS-REFERENCE TO RELATED APPLICATION

This application claims priority to and the benefit of Korean Patent Application No. 10-2024-0113649, filed on Aug. 23, 2024, the disclosure of which is incorporated herein by reference in its entirety.

### BACKGROUND

### 1. Field of the Invention

Various embodiments disclosed in this document relate to minimum risk maneuver technology of an autonomous driving system.

### 2. Description of Related Art

Recently, advanced driver assistance systems (ADAS) have been developed to assist drivers in driving, and autonomous driving systems are one example thereof. When an unexpected failure or abnormal situation occurs during autonomous driving and an autonomous driving system fails to properly respond, it may lead to a vehicle accident. In particular, when autonomous driving is performed without driver intervention, a serious accident may occur.

To prevent such an incident, an autonomous driving system may provide a minimum risk maneuver (MRM) to mitigate vehicle risks caused by events occurring during autonomous driving. An MRM is a maneuver operation performed to achieve a minimum risk condition (MRC), such as stopping in situations in which normal autonomous driving is not performable, such as HW/SW failures in an autonomous driving system, deviation from the operational design domain (ODD), vehicle malfunction or the like. An MRM may increase the reliability and safety of autonomous vehicles by supporting the vehicle in safely stopping or moving to a safe location in abnormal situations or failure states.

Conventional autonomous driving systems, upon satisfaction of MRM triggering conditions, perform MRM modes, such as stopping in an emergency mode, stopping while maintaining a lane, or stopping changing lanes to the right lane or the shoulder.

### SUMMARY OF THE INVENTION

The conventional MRM system for autonomous driving systems only considers road structures related to the lateral direction, such as lanes and road shoulders, and thus determines an MRM suitable only for road environments in which there are no longitudinal road structures, such as expressways or exclusive automobile roads. However, on urban roads, failure to consider stop lines and the like corresponding to longitudinal directions may result in things such as the risk of future collisions after stopping or stopping in areas in which stopping is prohibited by law. In addition, in driving environments that limit the autonomous driving performance of vehicles, such as adverse weather conditions or unstructured roads, it is required to determine an MRM that considers the performance of recognition/determination/control.

Various embodiments disclosed in this document may provide an electronic device and a method of controlling a minimum risk maneuver thereof that allow a vehicle to be stopped selectively using various stopping methods in the event of an error in an autonomous driving system.

According to an aspect of the present invention, there is provided an electronic device, which includes: a sensor module; a memory storing map data; and a processor functionally connected to the sensor module and the memory, wherein, when it is determined to execute a minimum risk maneuver (MRM) mode during autonomous driving, the processor recognizes a road structure and a static road object at a current location and a forward area from the current location based on the sensor module and map data, and determines a stopping method of the MRM mode according to a result of the recognition of the road structure and the static road object and stops the vehicle with the determined stopping method.

According to an aspect of the present invention, there is provided an electronic device, which includes: a sensor module; a memory storing map data; and a processor functionally connected to the sensor module and the memory, wherein, when it is determined to execute a minimum risk maneuver (MRM) mode during autonomous driving, the processor identifies a road structure within a threshold distance from a current location of a vehicle using the map data and the sensor module, and determines a stopping method among a plurality of MRM stopping methods based on the identified road structure and stops the vehicle with the determined stopping method.

According to an aspect of the present invention, there is provided an electronic device, which includes: a sensor module; a memory storing map data; and a processor functionally connected to the sensor module and the memory, wherein, when it is determined to execute an MRM mode during autonomous driving, the processor identifies a road structure within a threshold distance from a current location of a vehicle using the map data and the sensor module, and determines a stopping method among a plurality of MRM stopping methods based on the identified road structure, and stops the vehicle with the determined stopping method.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1 and 2 are drawings for describing problem situations of a minimum risk maneuver (MRM) mode;

FIG. 3 is a configuration diagram of an electronic device according to an embodiment;

FIG. 4 is a drawing for describing classification of MRM zones based on road risk levels according to an embodiment;

FIG. 5 is an exemplary diagram of classification of MRM sections based on a road structure according to an embodiment;

FIGS. 6 to 11 are exemplary diagrams of MRM stopping methods according to an embodiment;

FIG. 12 is an exemplary diagram of an electronic device including an MRM system and an autonomous driving system according to an embodiment;

FIG. 13 is an exemplary diagram of an MRM system implemented as hardware separate from an autonomous driving system according to an embodiment;

FIG. 14 is a schematic flowchart of a method of controlling an MRM according to an embodiment;

FIG. 15 is a flowchart of a method of determining an MRM mode according to an embodiment; and

FIG. 16 is a detailed flowchart of a method of controlling an MRM according to an embodiment.

In relation to the description of the drawings, identical or similar reference numerals may be used for identical or similar components.

### DETAILED DESCRIPTION OF EXEMPLARY EMBODIMENTS

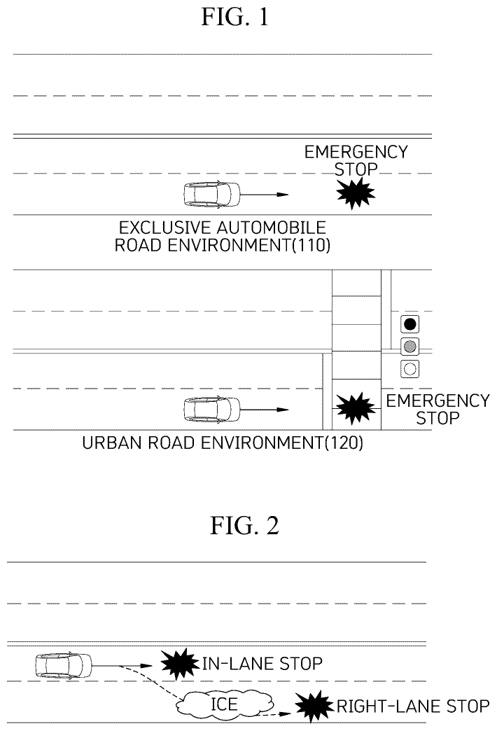

FIGS. 1 and 2 are drawings for describing problem situations of a minimum risk maneuver (MRM) mode.

Referring to FIG. 1, in a conventional autonomous driving system, an MRM system may perform an MRM mode by performing an emergency stop, stopping within a lane while maintaining the lane, or stopping on a right lane or shoulder through lane change when an MRM triggering condition is satisfied.

As shown in the upper example of FIG. 1, stopping on the right lane/shoulder may be suitable for an exclusive automobile road environment 110. However, as shown in the lower example of FIG. 1, in an urban road environment 120, various longitudinal road structures (e.g., a stop line, a crosswalk) are present, and therefore the conventional stopping method may make it difficult to ensure safety in compliance with legal regulations.

In addition, as shown in FIG. 2, in bad weather conditions (e.g., snow-covered roads or icy roads), stopping on the right lane/shoulder through a lane change in the MRM mode may be dangerous. In other words, in bad weather conditions, it is required to determine an MRM mode that has less impact on the vehicle driving performance, such as an MRM mode avoiding a lane change or adjusting deceleration.

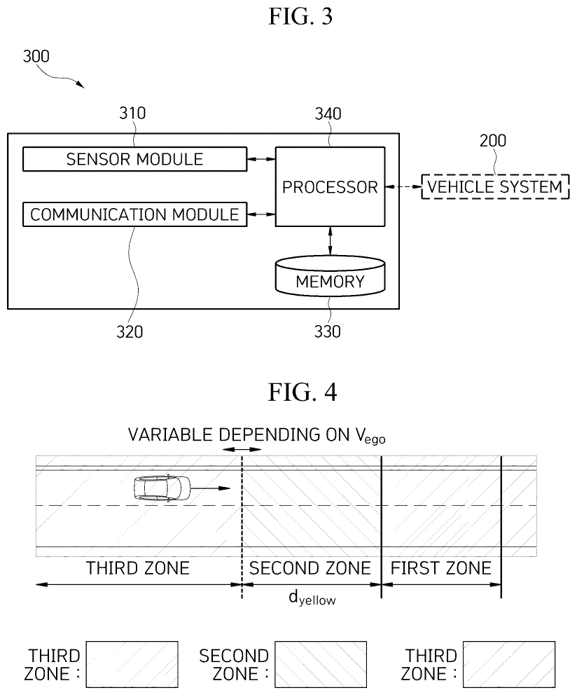

FIG. 3 is a configuration diagram of an electronic device according to an embodiment.

Referring to FIG. 3, an electronic device 300 according to an embodiment may include a sensor module 310, a communication module 320, a memory 330, and a processor 340. In an embodiment, some components of the electronic device 300 may be omitted or some components may be added. In addition, some of the components of the electronic device 300 may be combined to form a single component but may perform the same functions of the components before the combination. The electronic device 300 may be an MRM system or an autonomous driving system including an MRM system.

The sensor module 310 may detect a vehicle position, a vehicle state, and a surrounding environment. For example, the sensor module 310 may include a position sensor (e.g., a Global Positioning System (GPS) module) capable of detecting a vehicle position, and a state detection sensor capable of detecting a vehicle operating state, such as an engine speed. The vehicle operating state may include at least one vehicle state among a transmission state, an engine torque value, a brake operation state, an accelerator opening rate (or an accelerator pedal state), a steering angle, a speed, and an acceleration. The sensor module 310 may include a camera capable of capturing images of surroundings of the vehicle (e.g., front, rear, sides) and a light detection and ranging (LiDAR)/radar capable of detecting nearby objects (e.g., nearby vehicles).

The communication module 320 may support the establishment of a communication channel or a wireless communication channel between the electronic device 300 and another device (e.g., a vehicle system 200 or a roadside base station device), and the performance of communication through the established communication channel. The communication channel may include, for example, at least one of a local area network (LAN), fiber to the home (FTTH), a digital subscriber line (xDSL), wireless broadband (WiBro), a wireless LAN, WiFi, Bluetooth, ZigBee, Wi-Fi Direct (WFD), ultra-wideband (UWB), Infrared Data Association (IrDA), Bluetooth Low Energy (BLE), near field communication (NFC), 3G, 4G, or 5G. The communication channel may include a V2X communication channel, such as vehicle to vehicle (V2V), vehicle to infrastructure (V2I), vehicle to nomadic device (V2N), and vehicle to pedestrian (V2P). The communication channel may include at least one channel of a controller area network (CAN) or media oriented systems transport (MOST). The communication module 320 may perform communication using known communication methods such as code division multiple access (CDMA), Global System for Mobile Communications (GSM), W-CDMA, time division-synchronous code division multiple access (TD-SCDMA), WiBro, Long Term Evolution (LTE), Evolved Packet Core (EPC), etc.

The memory 330 may include various types of volatile memories or nonvolatile memories. For example, the memory 330 may include a read only memory (ROM) and a random access memory (RAM). In an embodiment, the memory 330 may be located inside or outside the processor 340, and the memory 330 may be connected to the processor 340 through various known means. The memory 330 may store various types of data used by at least one component of the electronic device 300 (e.g., the processor 340). The data may include, for example, input data or output data for software and instructions related thereto. For example, the memory 330 may store at least one instruction and data for performing autonomous driving service and an MRM. The memory 330 may store map data (e.g., a high definition map). The memory 330 may store data related to classification of MRM zones. For example, the memory 330 may store Expression 1 for calculating the range of a second zone (caution zone or yellow zone) and variables and constants of Expression 1. As constants related to Expression 1, the memory 330 may store deceleration values (a_{comfort}) based on weather and road surface conditions, including a first deceleration value (a_{dry}) for a dry road surface, a second deceleration value (a_{wet}) for a wet road surface, and a third deceleration value (a_{icy}) for a slippery road surface (ice and snow). The first to third deceleration values may be experimentally determined based on a braking distance of a vehicle according to a road surface condition and a speed and may be stored in the memory 330. The memory 330 may store instructions and data for determining a stopping method in an MRM mode.

The processor 340 may control at least one other component of the electronic device 300 (e.g., a hardware or software component) and perform various data processing or calculations. The processor 340 may include, for example, at least one of a central processing unit (CPU), a graphics processing unit (GPU), a microprocessor, an application processor, an application specific integrated circuit (ASIC), and a field programmable gate array (FPGA), and may have a plurality of cores. According to an embodiment, when it is determined to execute an MRM during autonomous driving of the vehicle, the processor 340 may determine an MRM mode and a stopping method depending on the road risk at the current location and whether a static road object is recognizable at the current location based on the sensor module 310 and the map data, and perform a vehicle stop with the determined stopping method in the determined MRM mode. In this regard, the processor 340 may classify the MRM zone at the current location according to the road risk and control the stopping method of the vehicle in the MRM mode differently according to the classified MRM zone at the current location.

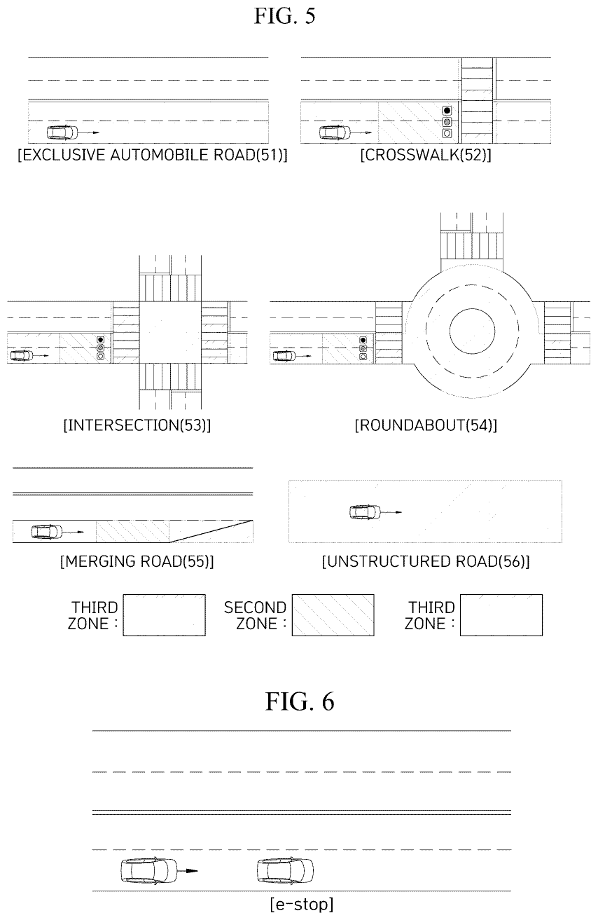

Hereinafter, classification of MRM zones according to an embodiment will be described with reference to FIGS. 4 and 5.

FIG. 4 is a drawing for describing classification of MRM zones based on road risk levels according to an embodiment. The road risk level (or friction) may be determined according to, for example, the road structure and road surface condition.

Referring to FIG. 4, the processor 340 may classify a current location into one of a plurality of MRM zones, that is, a first zone (a red zone) (dangerous zone), a second zone (a yellow zone) (caution zone), and a third zone (blue zone) (safe zone), according to the road structure and road surface condition. The first zone may be a road zone in which nearby objects and traffic lights need to be considered and there are legal restrictions on stopping. The first zone may include, for example, at least one of a crosswalk section, an intersection section, a lane reduction section of a merge road, and an entire section of an unstructured road. The second zone may be a road section located within a first distance (e.g., d_{yellow} in Expression 1) before reaching the first zone (or located within a first distance from the first zone) in which the vehicle cannot stop at a designated deceleration (e.g., a_{comfort} in Expression 1). The third zone is an area other than the first and second zones and may be an exclusive automobile road or a road section without a longitudinal road structure.

According to an embodiment, the processor 340 may calculate the range of the second zone according to weather and road surface conditions using Expression 1 below.

$${a}_{comfort} ∈ \{ {a}_{dry} , {a}_{wet} , {a}_{icy} \} \qquad [ Expression 1 ]$$

$${t}_{comfort} = \frac{{v}_{ego}}{{a}_{comfort}}$$

$${d}_{yellow} = {v}_{ego} \times {t}_{comfort} + \frac{{a}_{comfort} \times {t}_{comfort}^{2}}{2}$$

In Expression 1, a_{comfort} may be a deceleration value determined according to weather and a road surface. a_{comfort} may be selected from among a first deceleration value (a_{dry}) for a dry road surface, a second deceleration value (a_{wet}) for a wet road surface, and a third deceleration value (a_{icy}) for a slippery road surface (ice and snow). t_{comfort} may be a time required for comfortable stopping. v_{ego} may be a speed of the ego vehicle, and d_{yellow} may be a length of the second zone. The first to third deceleration values may be experimentally determined based on a braking distance of a vehicle according to a road surface condition and speed, and may be stored in the memory 330.

In this regard, the processor 340 may check whether the surface condition of the current road is a dry road surface condition, a wet road surface condition, or a slippery road surface condition based on weather and a result of detection of a road surface condition. For example, the processor 340 may check the weather through the communication module 320 or detect the road condition through the sensor module 310 (e.g., a weather sensor or a road detection sensor). For example, when rainy weather and a wet road condition are detected, the processor 340 determines that the road condition of the current road is a wet road condition. The processor 340 may apply a deceleration value according to the determined road condition of the current road and calculate the length of the second zone based on Expression 1.

FIG. 5 is an exemplary diagram of classification of MRM sections based on a road structure according to an embodiment.

Referring to FIG. 5, for an exclusive automobile road 51, in which there is no dangerous area in the longitudinal direction, the entire area may be set as the third zone. For a crosswalk section 52 with a crosswalk in an urban area, an area including the crosswalk may be set as the first zone. For an intersection section 53 and a roundabout section 54, an area including the crosswalk may be set as the first zone. For a merging road 55, a lane reduction section may be set as the first zone. For an unstructured road 56, the entire section of the unstructured road 56 may be set as the first zone.

According to an embodiment, the processor 340 may classify the MRM sections of the road currently being driven on and the road that will be driven on (the road ahead) based on the road structure at the current location and the forward area therefrom using the sensor module 310 and the map data of the memory 330. Alternatively, the map data includes information on the first zone (e.g., a link ID of a road belonging to the first zone and attribute information indicating the first zone) among the MRM sections of each road. In case, the processor 340 may classify the MRM sections at the current location or the forward area therefrom based on the information on the first zone.

According to an embodiment, when it is confirmed that there is a first zone within a threshold distance from the front of the vehicle, the processor 340 may input at least one variable of weather or a road condition and the vehicle speed into Expression 1 to calculate the range of the second zone. And the processor 340 may determine the remaining zone (the third zone) excluding the first and second zones. The threshold distance may be set to be, for example, greater than or equal to the maximum value of the first distance that may be calculated by Expression 1. The threshold distance may be set to be, for example, greater than or equal to the braking distance according to the current speed of the vehicle.

According to an embodiment, the processor 340 may stop in one of a plurality of stopping methods in the MRM mode depending on whether a road structure and a static object in front of the vehicle are recognizable.

Hereinafter, MRM stopping methods according to embodiments will be described with reference to FIGS. 6 to 11.

FIGS. 6 to 11 are exemplary diagrams of MRM stopping methods according to embodiments.

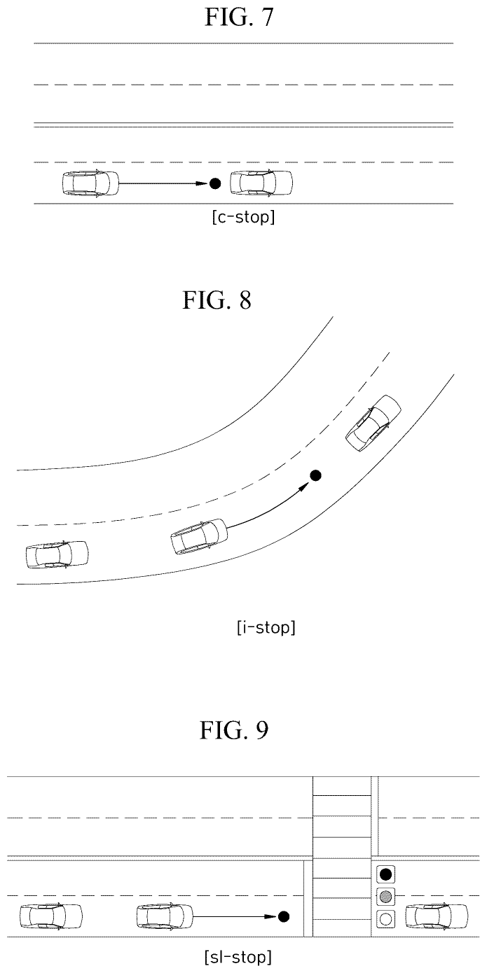

First, FIGS. 6 and 7 are examples of a method of stopping within a lane without considering a road structure.

Referring to FIG. 6, an emergency stop (e-stop) may be stopping at the maximum deceleration without considering the driving environment. According to an embodiment, the processor 340 may determine the MRM stopping method as an emergency stop when a static road object is not recognizable through the sensor module 310, or when a static road object is recognizable through the sensor module 310 but the vehicle is on or near a merging road.

Referring to FIG. 7, a comfort stop (c-stop) may be stopping that avoids colliding with a front vehicle in the driving direction while maintaining the last steering angle before the determination to execute the MRM. According to an embodiment, when a static road object is recognizable through the sensor module 310, but a road structure is not identifiable based on the map data and the current location, the processor 340 may determine the MRM stop method as a comfort stop. For a comfort stop, the processor 340 may stop the vehicle by gradually decelerating the vehicle while maintaining the last steering angle before executing the MRM mode without colliding with the vehicle ahead.

Next, FIGS. 8 to 10 are exemplary diagrams of in-lane stop methods considering road structure. In the case of FIGS. 8 to 10, control is performed assuming that there is a virtual lane for the vehicle to drive in, even in an environment in which no lane is present, such as a crosswalk or intersection.

Referring to FIG. 8, an in-lane stop (i-stop) may be a method of stopping while maintaining the lane and avoiding collisions with a surrounding vehicle (a vehicle ahead). The processor 340 may determine the MRM stopping method as an in-lane stop when the current location is a safe zone (third zone) and a static road object is recognizable, or when the current location is a dangerous zone of a roundabout.

Referring to FIG. 9, a stop line stop (sl-stop) may be a method of stopping in front of a stop line in an environment in which a crosswalk stop line is present. According to an embodiment, when a stop line is confirmed from a static road object and the current location is confirmed as a caution zone (second zone), the processor 340 may determine the MRM stopping method as a stop line stop except in a designated situation. The designated situation may include, for example, a case in which at least one of a driving signal or a left turn signal is confirmed at a traffic light ahead of the current location.

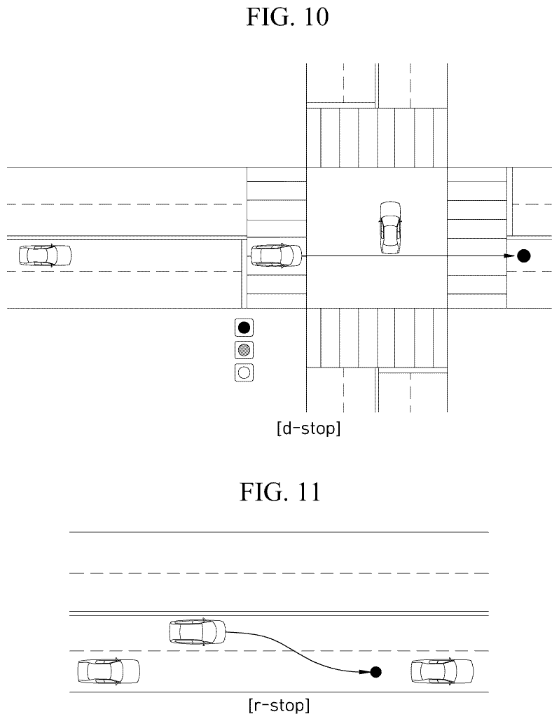

Referring to FIG. 10, a driving stop (d-stop) may be a method of stopping in a general lane after passing a crosswalk and intersection and driving without colliding with nearby vehicles. According to an embodiment, when a static road object is recognizable and it is confirmed that the current location is a dangerous zone (first zone), the processor 340 may stop after passing through the intersection or crosswalk, except in the case of a roundabout and a merging section.

Finally, FIG. 11 is an exemplary diagram of a right lane/shoulder stop method considering the road structure. In this case, the processor 340 may perform a lane change only in a section in which there is no longitudinal road structure, such as a crosswalk or an intersection.

Referring to FIG. 11, the right lane/shoulder stop (r-stop) may be a method of driving and stopping without causing a collision with a nearby vehicle in a section in which a longitudinal road structure is present. According to an embodiment, the processor 340 may determine the MRM stop method as the right lane/shoulder stop when the current location is a safe zone, not a merging road. The processor 340 may stop the vehicle on the right side or shoulder in which a longitudinal road structure is not present, in the MRM mode.

According to an embodiment, when it is determined to execute the MRM mode, the processor 340 may selectively execute one of the MRM modes among a non-road structure-based stop mode, a first road structure-based stop mode, or a second road structure-based stop mode.

According to one embodiment, when the road structure is not recognizable within a front threshold distance from the vehicle, the processor 340 may perform an emergency stop or a comfort stop as a stopping method of the non-road structure-based stop mode depending on whether a static road object is recognizable. For example, when the road structure is not recognizable and the static road object is not recognizable, the processor 340 may perform an emergency stop as shown in FIG. 6. On the other hand, when the road structure is not recognizable but the static road object is recognizable, the processor 340 may perform a comfort stop as shown in FIG. 7.

According to one embodiment, in the road structure-based stop mode, the processor 340 may determine the MRM stop method depending on whether a static object is recognizable, a traffic light is recognizable, and an MRM section is determinable. The processor 340 may determine the MRM stopping method based on the closest longitudinal road structure within a threshold distance from the current location.

In the road structure-based stop mode, the processor 340 may determine the MRM stopping method using Tables 1 to 7 below. In Tables 1 to 7, front/side in the static object recognition may indicate whether the processor 340 may detect a static object in front of or on the side of the vehicle through the sensor module 310. In addition, in Tables 1 to 7, green, red/yellow in the traffic light recognition may indicate the color of the recognized traffic light. For example, when the closest longitudinal road structure within a specific distance from the current location is a signal-controlled crosswalk, the processor 340 may determine the stopping method based on Table 2. i-stop/r-stop indicates a selection depending on whether a lane change is possible in the current situation. The stopping method may vary depending on the configuration of the autonomous vehicle and the MRM system, and in a situation in which the method described below is not applicable, the processor 340 may handle the situation with an emergency stop (e-stop) as a default.

TABLE 1
Longitudinal road structure absence
(e.g., exclusive automobile roads)

| Static object | Traffic light | | |
|---|---|---|---|
| recognition | recognition | Current zone | Stop type |
| X (forward) | N/A | Third zone | e-stop |
| ◯ (forward) | N/A | Third zone | i-stop/r-stop (side) |

TABLE 2
Signaled crosswalk

| Static object | Traffic light | | |
|---|---|---|---|
| recognition | recognition | Current zone | Stop type |
| X (forward/side) | X | Third zone | e-stop |
| | | Second zone | e-stop |
| | | First zone | e-stop |
| X (forward/side) | ◯ | Third zone | e-stop |
| | | Second zone | e-stop |
| | | First zone | e-stop |
| ◯ (forward/side) | X | Third zone | i-stop/r-stop |
| | | Second zone | sl-stop |
| | | First zone | d-stop |
| ◯ (forward/side) | ◯ (green) | Third zone | i-stop/r-stop |
| | | Second zone | d-stop |
| | | First zone | d-stop |
| | ◯ (red/yellow) | Third zone | i-stop/r-stop |
| | | Second zone | sl-stop |
| | | First zone | d-stop |

TABLE 3
Non-signaled crosswalk

| Static object | Traffic light | | |
|---|---|---|---|
| recognition | recognition | Current zone | Stop type |
| X (forward/side) | N/A | Third zone | e-stop |
| | | Second zone | e-stop |
| | | First zone | e-stop |
| ◯ (forward/side) | N/A | Third zone | i-stop/r-stop |
| | | Second zone | sl-stop |
| | | First zone | d-stop |

TABLE 4
Signaled crosswalk

| Static object | Traffic light | | |
|---|---|---|---|
| recognition | recognition | Current zone | Stop type |
| X (forward/side) | X | Third zone | e-stop |
| | | Second zone | e-stop |
| | | First zone | e-stop |
| X (forward/side) | ◯ | Third zone | e-stop |
| | | Second zone | e-stop |
| | | First zone | e-stop |
| ◯ (forward/side) | X | Third zone | i-stop/r-stop |
| | | Second zone | sl-stop |
| | | First zone | d-stop |
| ◯ (forward/side) | ◯ (green/left) | Third zone | i-stop/r-stop |
| | | Second zone | d-stop |
| | | First zone | d-stop |
| | ◯ (red/yellow) | Third zone | i-stop/r-stop |
| | | Second zone | sl-stop |
| | | First zone | d-stop |

TABLE 5
Non-signaled crosswalk

| Static object | Traffic light | | |
|---|---|---|---|
| recognition | recognition | Current zone | Stop type |
| X (forward/side) | N/A | Third zone | e-stop |
| | | Second zone | e-stop |
| | | First zone | e-stop |
| ◯ (forward/side) | N/A | Third zone | i-stop/r-stop |
| | | Second zone | sl-stop |
| | | First zone | d-stop |

TABLE 6
Roundabout

| Static object | Traffic light | | |
|---|---|---|---|
| recognition | recognition | Current zone | Stop type |
| X (forward/side) | N/A | Third zone | e-stop |
| | | Second zone | e-stop |
| | | First zone | e-stop |
| ◯ (forward/side) | N/A | Third zone | i-stop/r-stop |
| | | Second zone | sl-stop |
| | | First zone | i-stop |

TABLE 7
Merging Road

| Static object | Traffic light | | |
|---|---|---|---|
| recognition | recognition | Current zone | Stop type |
| X (forward/side) | N/A | Third zone | e-stop |
| | | Second zone | e-stop |
| | | First zone | e-stop |
| ◯ (forward/side) | N/A | Third zone | i-stop |
| | | Second zone | e-stop |
| | | First zone | e-stop |

As described above, the electronic device 300 according to an embodiment may provide an MRM that is applicable not only to an exclusive automobile road but also to an urban road by considering the driving performance under adverse weather conditions and longitudinal/lateral road structures.

In addition, the electronic device 300 according to an embodiment may reduce the risk of front/rear collision by reducing sudden stops in the MRM mode as much as possible by considering adverse weather conditions and road structures, and may reduce the possibility of collision after MRM execution by lowering the frequency of stops at crosswalks, intersections, and roundabouts, and may comply with legal regulations as much as possible.

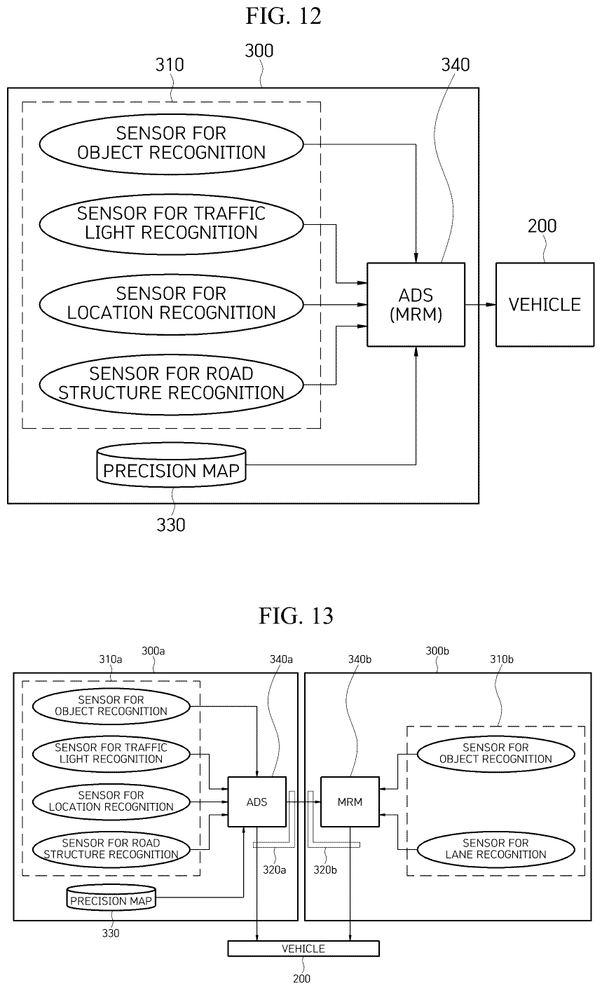

FIG. 12 is an exemplary diagram of an electronic device including an MRM system and an autonomous driving system according to an embodiment.

Referring to FIG. 12, an electronic device 300 according to an embodiment may include an MRM system and an autonomous driving system. In this case, the MRM system and the autonomous driving system may share a sensor module 310, a memory 330, and a processor 340.

FIG. 13 is an exemplary diagram of an MRM system implemented as hardware separate from an autonomous driving system according to an embodiment. In this case, the electronic device 300 may be an MRM system 300b that communicates with an autonomous driving system 300a.

Referring to FIG. 13, the MRM system 330b according to an embodiment may be configured as a hardware device separate from the autonomous driving system 330a. The autonomous driving system 330a may perform autonomous driving through a first sensor module 310a, and the MRM system 330b may recognize a static object or a lane through a second sensor module 310b. The MRM system 330b may monitor the surrounding situation of the vehicle, the surrounding environment, and the driver's state through the second sensor module 310b and a first communication module 320a, and may monitor vehicle system errors through first and second communication modules 320a and 320b. When it is determined to execute the MRM based on a result of the monitoring, the MRM system 330b may determine a stopping method of the MRM modes based on whether the autonomous driving system 330a recognizes road structures and static road objects. The MRM system 330b may stop the vehicle by controlling the vehicle system 200 in the determined method. In the above-described embodiment, some of the operations of the MRM system 330a may be performed by the autonomous driving system 330a. Conversely, the opposite is also possible.

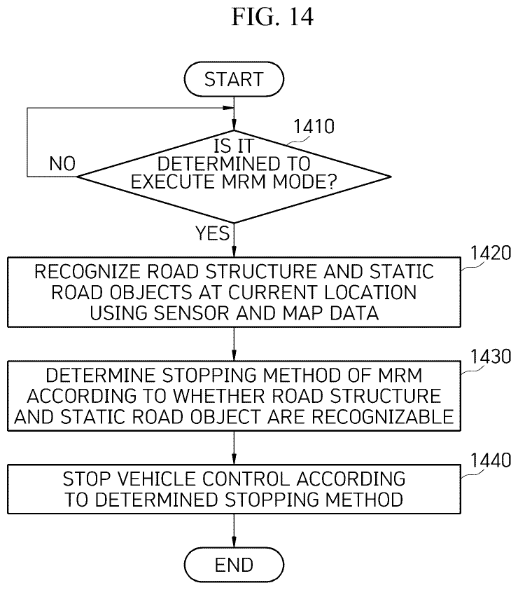

FIG. 14 is a schematic flowchart of a method of controlling an MRM according to an embodiment.

Referring to FIG. 14, in operation 1410, the electronic device 300 may confirm that it is determined to execute the MRM mode during autonomous driving, and in operation 1420, the electronic device 300 may recognize a road structure and a static road object at the current location using the sensor module and the map data.

In operation 1430, the electronic device 300 may determine the stopping method of the MRM mode according to whether the road structure and the static road object are recognizable.

In operation 1440, the electronic device 300 may stop the vehicle by controlling the vehicle system 200 according to the determined stopping method.

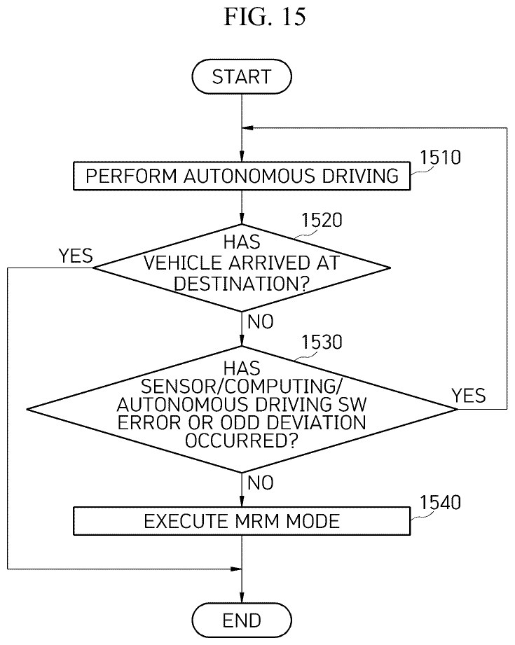

FIG. 15 is a flowchart of a method of determining an MRM mode according to an embodiment.

Referring to FIG. 15, in operation 1510, the electronic device 300 may autonomously drive the vehicle along a path to a destination in an autonomous driving mode.

In operation 1520, the electronic device 300 may monitor whether the vehicle arrives at the destination by autonomously driving. When the electronic device 300 arrives at the destination, the electronic device 300 may terminate the autonomous driving.

In operation 1530, the electronic device 300 may check whether a condition for triggering MRM is satisfied before arriving at the destination. For example, when the electronic device 300 confirms at least one of: a case in which a sensor/computing/autonomous driving SW error occurs or a case in which an operational design domain (ODD) deviation occurs, the electronic device 300 may determine that the condition for triggering an MRM is satisfied. The ODD may represent conditions and environments for which the autonomous driving system is designed, and may include, for example, a geographical region, a road type, traffic conditions, weather conditions, and a time zone.

In operation 1540, when it is confirmed in operation 1530 that the condition for triggering an MRM is satisfied, the electronic device 300 may switch to the MRM mode.

The electronic device 300 may control the vehicle autonomous driving when it is confirmed in operation 1530 that that the condition for triggering an MRM is not satisfied, or in operation 1510.

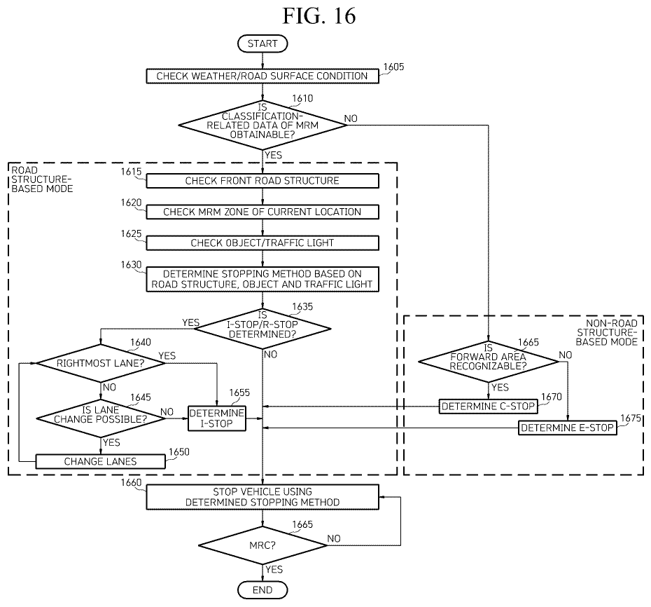

FIG. 16 is a detailed flowchart of a method of controlling an MRM according to an embodiment.

Referring to FIG. 16, in operation 1605, the electronic device 300 may check weather and road surface condition information using a weather/road surface sensor (a sensor module 310).

In operation 1610, the electronic device 300 may check whether classification-related data of an MRM zone is obtainable using at least one of map data and a road structure recognition function. For example, the electronic device 300 may check whether an error of the autonomous driving system that has caused an MRM trigger makes it difficult to obtain classification-related data of the MRM zone. The classification-related data may include, for example, current location information of the vehicle and attribute information of map data (e.g., longitudinal road structure information).

When it is confirmed in operation 1610 that classification-related data of the MRM zone is not obtainable, the electronic device 300 may switch to a non-road structure-based stop mode.

In operation 1665, the electronic device 300 may check whether a forward area is recognizable using the sensor module 310 in the non-road structure-based stop mode.

In operation 1670, the electronic device 300 may determine a comfort stop (c-stop) as the MRM stopping method when it is confirmed that the forward area is recognizable in operation 1665.

On the other hand, in operation 1675, the electronic device 300 may determine an emergency stop (e-stop) as the MRM stopping method when it is confirmed that the forward area is not recognizable in operation 1665.

When it is confirmed in operation 1610 that the classification-related data of the MRM zone is obtainable, in operation 1615, the electronic device 300 may check a front road structure using at least one of the map data and the road structure recognition function

In operation 1620, the electronic device 300 may check the MRM zone at the current location using the front road structure. For example, the electronic device 300 may determine which of the first to third zones the current location belongs to using the longitudinal road structure ahead in the driving direction of the vehicle. The first zone may include, for example, a crosswalk section, an intersection section, a lane reduction section of a merge road, or an entire section of an unstructured road. The second zone may be a road section at a first distance before reaching the first zone (or within a first distance from the first zone) in which stopping is not possible with a designated deceleration. The third zone is an area other than the first and second zones and may be a road exclusive for automobiles or a road section without a longitudinal road structure.

In operation 1625, the electronic device 300 may check a static road object and a traffic light using the sensor module 310. Additionally or alternatively, the electronic device 300 may determine a traffic light state based on traffic information (e.g., traffic light information) received through the communication module 320.

In operation 1630, the electronic device 300 may determine the stopping method of the MRM mode by considering the road structure as shown in Tables 1 to 7 described above, based on the result of the classification of the MRM zone, the static object, and the traffic light state. The stopping method of the MRM mode may include at least one of an in-lane stop, a stop line stop, a right lane/shoulder stop, and a driving stop.

In operation 1635, the electronic device 300 may check whether the determined stopping method is an in-lane stop or a right lane/shoulder stop (i-stop/r-stop).

In operation 1640, when it is confirmed in operation 1635 that the determined stopping method is “i-stop/r-stop,” the electronic device 300 may check whether the current driving lane is the rightmost lane.

In operation 1645, the electronic device 300 may check whether a lane change is possible when it is confirmed in operation 1640 that the current driving lane is not the rightmost lane.

In operation 1650, the electronic device 300 may change lanes when it is confirmed in operation 1645 that a lane change is possible.

In operation 1655, the electronic device 300 may determine the MRM stopping method as an in-lane stop (i-stop) when it is confirmed that the current driving lane is the rightmost lane in operation 1640, or it is confirmed that a lane change is not possible in operation 1645.

In operation 1660, the electronic device 300 may stop the vehicle using the determined stopping method when it is confirmed in operation 1635 that the determined stopping method is not “i-stop/r-stop”, or when the stopping method is determined in operations 1655, 1670 or 1675.

In the operations 1660 to 1665, the electronic device 300 may continue the stop control of the determined stop mode until the vehicle is stopped in the determined stop mode of the MRM mode and switched to a minimum risk condition.

As described above, the electronic device 300 according to an embodiment may provide an MRM applicable not only to an exclusive automobile road but also to an urban road by considering the driving performance under adverse weather and longitudinal/lateral road structure.

In addition, the electronic device 300 according to an embodiment may reduce the risk of front/rear collision by reducing sudden stopping in the MRM mode as much as possible by considering adverse weather conditions and road structures, and may reduce the possibility of collision after MRM execution by lowering the frequency of stopping at crosswalks, intersections, and roundabouts and may comply with legal regulations as much as possible.

The various embodiments of the disclosure and terminology used herein are not intended to limit the technical features of the disclosure to the specific embodiments, but rather should be understood to cover all modifications, equivalents, and alternatives falling within the spirit and scope of the disclosure. Like numbers refer to like elements throughout the description of the drawings. The singular forms preceded by “a” and “an” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc., are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” A module may be an integrally configured component or a minimum unit or part of the integrally configured component that performs one or more functions. For example, according to one embodiment, a module may be implemented in the form of an ASIC.

The various embodiments of the present disclosure may be realized by software (e.g., a program) including one or more instructions stored in a storage medium (e.g., the memory 330 in FIG. 3) (e.g., an internal memory or external memory,) that can be read by a machine (e.g., an autonomous driving system). For example, a processor (e.g., the processor 340 of the machine) (e.g., the electronic device 300) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure may be implemented in the form of software or hardware, such as a digital signal processor (DSP), an FPGA or an ASIC, and may perform predetermined functions. The term “elements” is not limited to meaning software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

According to the various embodiments disclosed in this document, a vehicle can be stopped more safely through various stopping methods when an error occurs in an autonomous driving system. In addition, various effects that are directly or indirectly identified through this document can be provided.

What is claimed is:

1. An electronic device comprising:
a sensor module;
a memory storing map data; and
a processor functionally connected to the sensor module and the memory,
wherein, when it is determined to execute a minimum risk maneuver (MRM) mode during autonomous driving, the processor recognizes a road structure and a static road object at a current location and a forward area of a vehicle based on the sensor module and map data, and
determines a stopping method of the MRM mode according to a result of the recognition of the road structure and the static road object and stops the vehicle with the determined stopping method.

2. The electronic device of claim 1, wherein, when the road structure or the static road object is unrecognizable through the sensor module, or when the static road object is recognizable but the road structure is a merging road or is adjacent to the merging road, the processor stops the vehicle at a maximum deceleration rate.

3. The electronic device of claim 1, wherein, when the static road object is recognizable through the sensor module but the road structure is not identifiable from the map data, the processor stops the vehicle by gradually decelerating the vehicle while maintaining a last steering angle before the execution of the MRM without colliding with a preceding vehicle.

4. The electronic device of claim 1, wherein, when the road structure at the current location is identifiable, the processor classifies MRM zones at the current location and the forward area of the vehicle and determines a stop mode of the vehicle based on the classified MRM zone.

5. The electronic device of claim 4, wherein, when it is confirmed that there is at least one area among an intersection area, a crosswalk area, a lane reduction area of a merge road, or an entire area of an unstructured road within a threshold distance from the current location, the processor determines the at least one area to be a dangerous zone.

6. The electronic device of claim 4, when the MRM zones is determined as a dangerous zone, the processor calculates a distance required for a comfort stop based on a deceleration value adjusted according to weather and road conditions and a current vehicle speed and determines a road within the calculated distance before the dangerous zone to be a caution zone.

7. The electronic device of claim 1, wherein, when the current location or the forward area is a dangerous zone of a roundabout, or when the current location is a designated safety zone and the static road object is recognizable, the processor stops the vehicle while maintaining a lane of the vehicle and avoiding a collision with a nearby vehicle.

8. The electronic device of claim 7, wherein, when the current location or the forward area is not a merging road but the safety zone, the processor stops the vehicle while maintaining the lane or stops on a right side or a road shoulder in which no longitudinal road structure is present.

9. The electronic device of claim 1, wherein, when a stop line is confirmed from a static road object within a threshold distance from the current location and the current location is confirmed as a designated caution zone, the processor stops the vehicle at the confirmed stop line except in a designated situation, and
in the designated situation, stops after passing a crosswalk or intersection while avoiding a collision with a surrounding vehicle,
wherein the designated situation includes a case in which at least one of a driving signal or a left turn signal is confirmed at a traffic light ahead of the current location.

10. The electronic device of claim 1, wherein, when the static road object is recognized and a designated dangerous zone within a threshold distance from the current location is confirmed, the processor stops after passing an intersection or crosswalk except in cases of a roundabout and a merging section.

11. An electronic device comprising:
a sensor module;
a memory storing map data; and
a processor functionally connected to the sensor module and the memory,
wherein, when it is determined to execute a minimum risk maneuver (MRM) mode during autonomous driving, the processor identifies a road structure within a threshold distance from a current location of a vehicle using the map data and the sensor module, and
determines a stopping method among a plurality of MRM stopping methods based on the identified road structure and stops the vehicle with the determined stopping method.

12. The electronic device of claim 11, wherein, when the road structure is not identifiable using the map data and the sensor module, the processor performs an emergency stop that decelerates to a maximum deceleration rate or a comfort stop that adjusts a deceleration, depending on whether a static road object is recognizable through the sensor module.

13. The electronic device of claim 11, wherein, when the road structure is identifiable, the processor determines the MRM stopping method based on at least one of a traffic light state, a longitudinal road structure, and an MRM zone classification within the threshold distance from the current location using the map data and the sensor module.

14. The electronic device of claim 11, wherein the MRM stopping method includes a plurality of methods including an emergency stop, a comfort stop, a stop on a right road or a road shoulder, a stop within a lane, and a stop after driving.

15. The electronic device of claim 11, wherein, when it is confirmed that there is at least one area among an intersection area, a crosswalk area, a lane reduction area of a merge road, or an entire area of an unstructured road within the threshold distance, the processor determines the current location to be a dangerous area.

16. The electronic device of claim 11, wherein the processor calculates a distance required for a comfort stop based on a deceleration value designated according to weather and road conditions and a current vehicle speed and determines an area within the calculated distance or smaller before a dangerous zone within the threshold distance to be a caution zone.

17. The electronic device of claim 11, wherein the processor determines an area excluding a designated dangerous zone and a designated caution zone to be a safety zone.

18. A method of controlling a minimum risk maneuver (MRM), which is performed by at least one processor, comprising:
when it is determined to execute an MRM mode during autonomous driving, recognizing a road structure and a static road object at a current location and a forward area of a vehicle based on a sensor module and map data;
determining a stopping method of the MRM mode depending on whether the road structure and the static road object are recognizable; and
stopping the vehicle with the determined stopping method.

19. The method of claim 18, wherein the determining includes, when the road structure is not identifiable using the map data and the sensor module, determining an emergency stop that decelerates to a designated maximum deceleration rate or a comfort stop that adjusts a deceleration depending on whether a static road object is recognizable through the sensor module.

20. The method of claim 18, wherein the determining includes, when the road structure is identifiable, determining the MRM stopping method based on at least one of a traffic light state, a longitudinal road structure, and an MRM zone classification of the current location and the forward area using the map data and the sensor module.
